(19) United States
(12) Patent Application Publication
(10) Pub. No.: US 2014/0229394 A1
(43) Pub. Date: Aug. 14, 2014

(54) Renewable energy credit management system and method

(71) Applicant: Open Access Technology International, Minneapolis, MN (US)

(72) Inventors: Ilya Slutsker, Plymouth, MN (US); Carlos Gonzalez-Perez, Maple Grove, MN (US); John Lundstedt, Minneapolis, MN (US); Nirmalya Banerjee, Maple Grove, MN (US); Shankar Rajagopalan, Houston, TX (US); Sasan Mokhtari, Eden Prairie, MN (US)

(73) Assignee: Open Access Technology International, Minneapolis, MN (US)

(21) Appl. No.: 14/176,590

(22) Filed: Feb. 10, 2014

Related U.S. Application Data
(60) Provisional application No. 61/762,653, filed on Feb. 8, 2013.

(51) Int. Cl. G06Q 30/00

(52) U.S. Cl. CPC G06Q 30/018
USPC 705/317

(57) ABSTRACT

The invention provides a method of automatically attributing energy and Renewable Energy Credits (RECs) to contractual and market obligations. The input of energy and RECs will automatically fit into existing data models, allowing immediate attribution upon upload. The invention will immediately calculate the energy balance of the input, accounting for such factors as resource generation, energy inputs, native load, station service, and obligations. Users can specify numerous energy and REC sources to be attributed simultaneously, such attribution happening according to either system or user-defined attribution policies. The invention allows users to manipulate the data to best facilitate use of their RECs, displaying REC positions over user-specified periods of time.

### CROSS-REFERENCE TO RELATED APPLICATIONS

This application claims priority to provisional patent application 61/762653, filed Feb. 8, 2013, the entire contents of which are hereby incorporated by reference.

### STATEMENT REGARDING FEDERALLY SPONSORED RESEARCH

Not Applicable.

### FIELD OF THE INVENTION

The present invention relates generally to Renewable Energy Credit (REC) generation and allotment within and among entities which generate, buy, and sell RECs, and in particular to software that simplifies accounting of RECs in their various stages.

### BACKGROUND OF THE INVENTION

There is an increasing push to generate electricity from renewable energy resources. This is coming from all areas of our world, including from consumers demanding environmentally friendly companies and governments regulating environmentally friendly business. This movement has led to increased regulations regarding the electricity grid in sizeable, growing chunk of the world. These regulations require energy providers to produce minimum amounts of renewable energy as part of their total energy production.

To aid in regulation, production of renewable energy is tracked with many different units of measurement, one of which is called Renewable Energy Credits or Certificates (REC). RECs are allotted to renewable energy generation resources by Regional Renewable Energy Tracking Organizations. These Regional Renewable Energy Tracking Organizations then monitor compliance to ensure that energy providers are within their Renewable Portfolio Standards. If an energy provider has an excess of RECs, that energy provider can sell its RECs to another energy provider in need of REC. These transactions ensure an energy provider is always paying to produce renewable energy. Tracking of RECs currently involves multiple manual operations in a number of different systems, requiring that data be re-entered in each system. This process is time-consuming and error prone.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety. Without limiting the scope of the invention, a brief summary of some of the claimed embodiments of the invention is set forth below. Additional details of the summarized embodiments of the invention and/or additional embodiments of the invention may be found in the Detailed Description of the invention below. A brief abstract of the technical disclosure in the specification is provided for the purposes of complying with 37 C.F.R. §1.72.

### BRIEF SUMMARY OF THE INVENTION

In at least one embodiment, the invention is directed to a computer program for use with a graphics display device, the computer program comprising a computer usable medium having computer readable program code means embodied in the medium for modeling, organizing, and reporting the organization's REC generation and allotment. The computer program comprises computer readable program code means for creating a rule governing REC/energy allotment from a given entity for a given obligation (Obligation), wherein the rule comprises a plurality of energy components, the finished allotment then being turned into single rule, the rule being arranged in sequential order according to a user-specified required order of execution of rules. The computer readable program code also provides for means for displaying a report on REC generation and allotment and computer readable program code means for analyzing, monitoring, and projecting past, present, and future REC generation and allotment, respectively.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWINGS

The present invention will be explained in more detail below by means of drawings.

FIG. 1—Flow of Information through the invention

FIG. 2—input of Data into invention

FIG. 3A-3B—Allocation of RECs

FIG. 4A-4B—Allocation of Energy

FIG. 5A-5C—Attribution Policies

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

Embodiments of the present invention remove the complexity associated with the current state of tracking in the art. As a non-limiting example, users enter a minimal amount of data on a single display. Users are informed in real time about the status of their RECs. All created objects (rules, reports, transactions, future allotments) are available in a single tool. A Rule is defined to be a logic structure utilized to define unique allotments of generation to obligation via availability, user-specified Priority of Resources, and allocation policies.

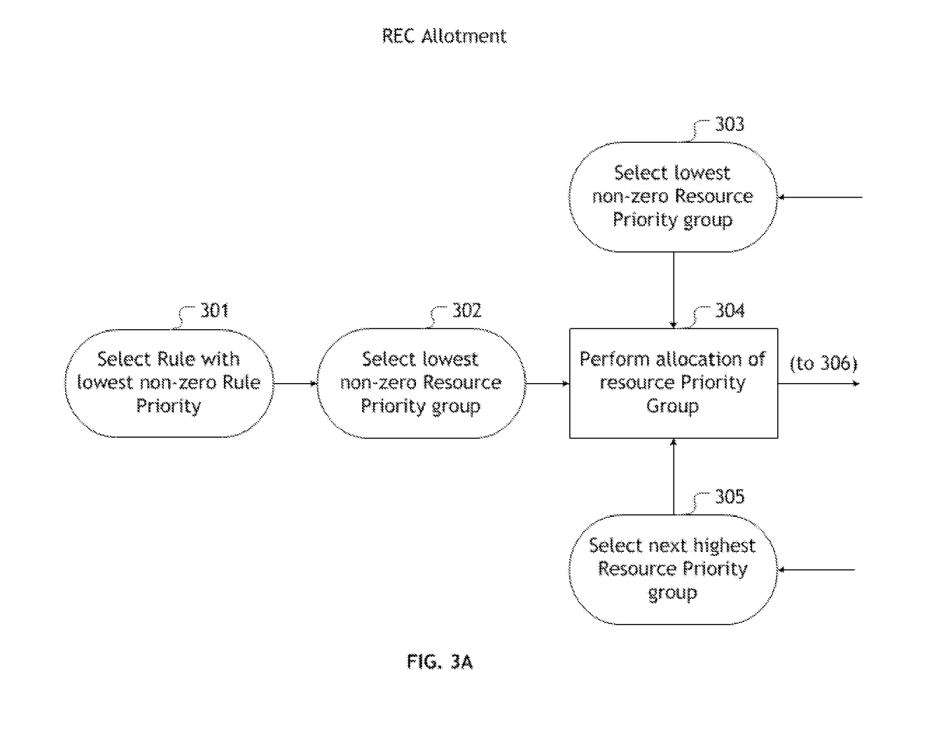

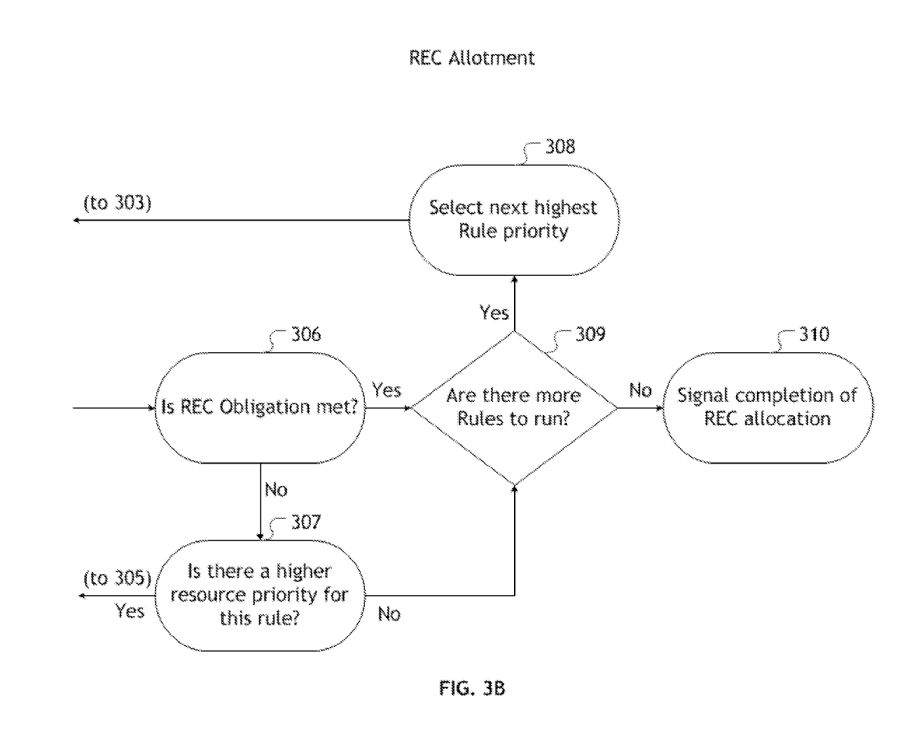

As seen in FIGS. 3, 4, and 5, the system then runs through the various electricity-generating units which qualify for RECs (Resources) in the Rule in coherent work patterns along with internal execution routing (what-if-then logic) and the data profile required to support Resource-selection criteria. Each Rule is encoded with all necessary characteristics as far as its data needs, execution logic, and interaction with users are concerned.

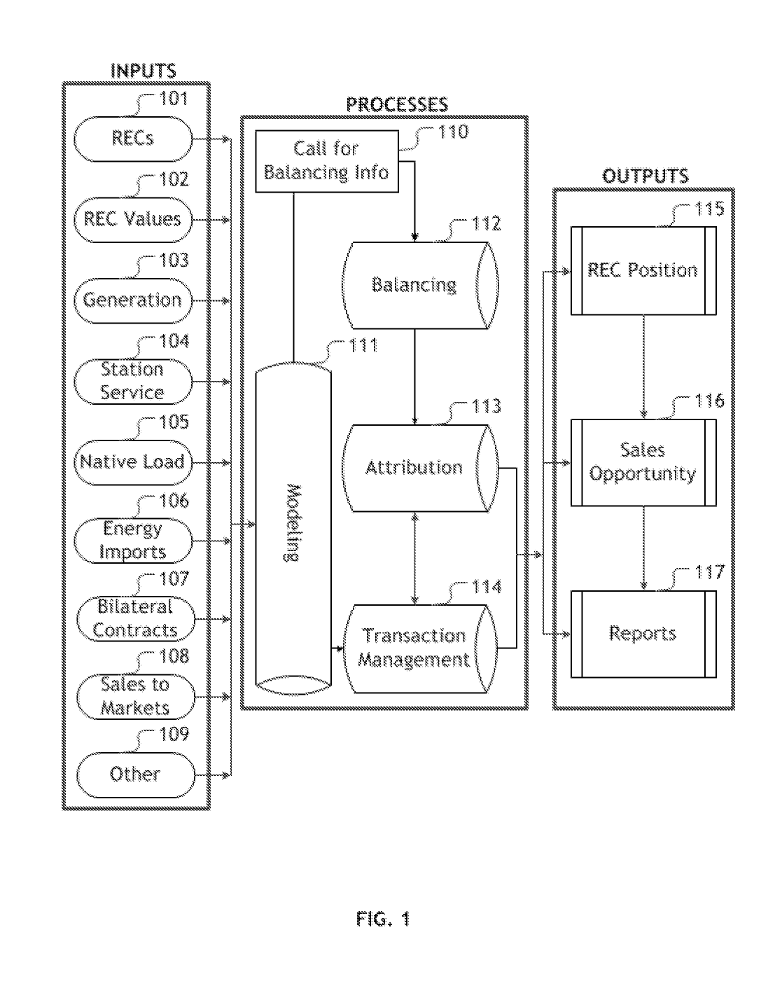

The system of method begins with the input of data into the software processes as seen in FIG. 1, this input comprising data associated with Resources, the energy generated 103 and used 104 by such Resources for a given month (Vintage Month), the energy generally required for each Resource 105, the RECs 101 earned with such generation, the current price for RECs 102 in different REC-allotting jurisdictions in which the user might buy/sell, the user's energy sales through bilateral contracts 107 and sales to market 108, the user's energy imports 106, and the current and past REC contracts 107 with MWh amounts which the user is under obligation for (Obligations) whether for RECs or energy. The system can also be configured to identify and accept upload of other data 109 which the user finds necessary or helpful for REC attribution or management.

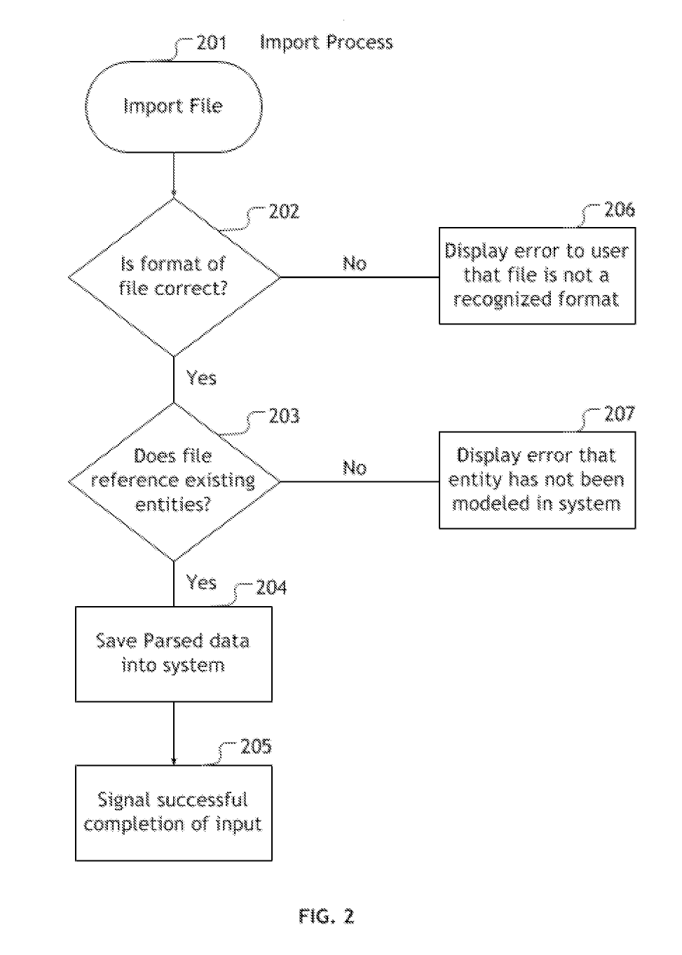

The system can be made to receive the data via numerous methods, such as but not limited to having the user responsible for uploading this data “ready-to-use” in compliant XML format. Upload can be assisted by the system allowing a user to navigate to find an import file, granted that the import file is either on user's computer or a network drive which is accessible from user's computer. Before import, the user is able to view the file to ensure accuracy. Turning now to FIG. 2, during this a validation is performed to ensure the file is in compliant format 202 and is modeled correctly 203, with errors of format 206 or modeling 207 made known to the user. In order to avoid compromise of system data, a tile with such an error of format 206 or modeling 207 cannot be uploaded. The system is also set up to specify that all uploads are for a specific time period, such as but not necessarily limited to a full Vintage Month, without allowing partial incremental updates or uploads.

Attempts to import a file 201 are recorded with the recorded information comprising the success 205 or failure 206/207 of the upload attempt, the timestamp of import, the file name, the information type, and the name of the user.

In some particular embodiments, in the course of such communications between devices the invention may further utilize encryption enabling software, such as but not necessarily limited to digital certificates, to secure access to the system and encrypt communications sent to and from the system. Using any number of methods known in the art, the invention may require and validate for the presence of specific encryption enabling software as a login credential. In preferred embodiments, such encryption enabling software is associated on a one-to-one basis with a particular user account. Login to the system of such embodiment would be denied unless the system validates, using any method known in the art, that a user's request to access the system includes the correctly corresponding login credentials comprising of username, password, and encryption enabling software, among others, associated with a particular predefined user account. Moreover, in other embodiments, encryption enabling software may be utilized to encrypt data communications within the invention or between the invention and other systems.

Moreover, communications between the inventive system/method and other destination systems may also be encrypted with encryption enabling software. Such encryption can be accomplished using any known means available in the art. As a non-limiting example, both the system of the present disclosure and a destination system can be set up with encryption enabling software, such as but not necessarily limited to digital certificates, to facilitate the encryption of communication sent from one system and the subsequent decryption of the information by the recipient system. Such pre-incorporation of encryption enabling software by both the sending system and recipient systems ensures that any intercepted communications cannot be read, thus raising the confidence level of transactions occurring within the system as a whole.

Successfully passing validation checks for format 206 and modeling 207, data is parsed into the system 204. Once saved to the system 204, all data inputted to the system can be viewed, modified, or allocated. The system also allows data to be viewed in different time formats such as but not necessarily limited to hourly or monthly formats. The system may facilitate the creation of system users with various levels of authorization, such that only users with assigned permissions can perform specific actions. In such an embodiment, the system may prevent all but specially authorized users from modifying inputted data.

Data which is brought into the system must fit into a pre-existing model. This model looks to verify that every incoming Obligation has been matched with Resources 111. This method of matching needs only be done once, though the data can be edited and updated at any time.

Every time a REC is sold or purchased in the system, the system tracks this with a transaction (Transaction). A number of Transaction types are supported as valid by the system, such Transaction types comprising sale to counterparty, purchase from a counterparty, assignment of RECs to a contract in a binding arrangement, assignment of RECs to a market, assignment of RECs to load, expiration of RECs, and inventory adjustment. On a REC Transaction, types of information which are supported as a valid input may comprise but are not limited to Resource, Vintage Month, REC quantity, Price, Comments, Currency, Broker Name, Broker Commission Type (percentage or fixed monetary amount), Broker Commission Dollar Amount, Comments, and Deal Date, among others. Varieties of REC transaction statuses which are supported may comprise but are not limited to Pending, Confirmed, Invoiced, Paid, Credits Transferred, and Transfer Acknowledged, among others.

Once balancing is called for 110 whether because of Attribution 113 or a user call for balancing data, the system finds the net energy balance 112 (Energy Balance) of the upload. The system associates each of the Resources with both the amount of energy generated by the Resource 103 (Gross Generation) and the amount of energy consumed by a Resource 104 (Service Station). The system then computes the Resource Net Generation as Gross Generation minus Station Service, where Gross Generation is greater than or equal to Station Service. The system may take other factors into account. Such factors may comprise but are not limited to imported energy 106 (Imports), the user's native need for energy 105 (Native Load), contractual sales of energy to a counterparty 107 (Bilateral Sales), and sales of energy to a market 108 (Market Sales). In one particular embodiment, the system quantifies the amount of energy available (Net Energy Available) by adding Imports 106 to Resource Net Generation. In order to calculate the total energy requirement (Net Obligation) of the upload 201, the system adds the Native Load 105, Negative Service Station 104, Bilateral Sales 107, and Market Sales 108. To quantify the system losses (Losses), the system then subtracts the Obligations from the Net Energy Available. The system then calculates how much energy was supplied by adding together Net Obligations and Losses. Finally, a user's net load (Net Load) is calculated as the Native Load 105 added to the Negative Station Services 104 and the Losses. The system performs all such calculations automatically at the moment attribution 113 is triggered, or at the moment the system balance 112 screen is opened by a user.

The system can also be configured to not allow user intervention to achieve such energy balance as described above. Such configuration can be then utilized to maintain the integrity of the balancing and therein the eventual attribution 113 of energy and RECs. In one particular embodiment, when the absolute value of calculated losses exceeds a user-defined percentage of Net Energy Available, the system may provide the user with an alert.

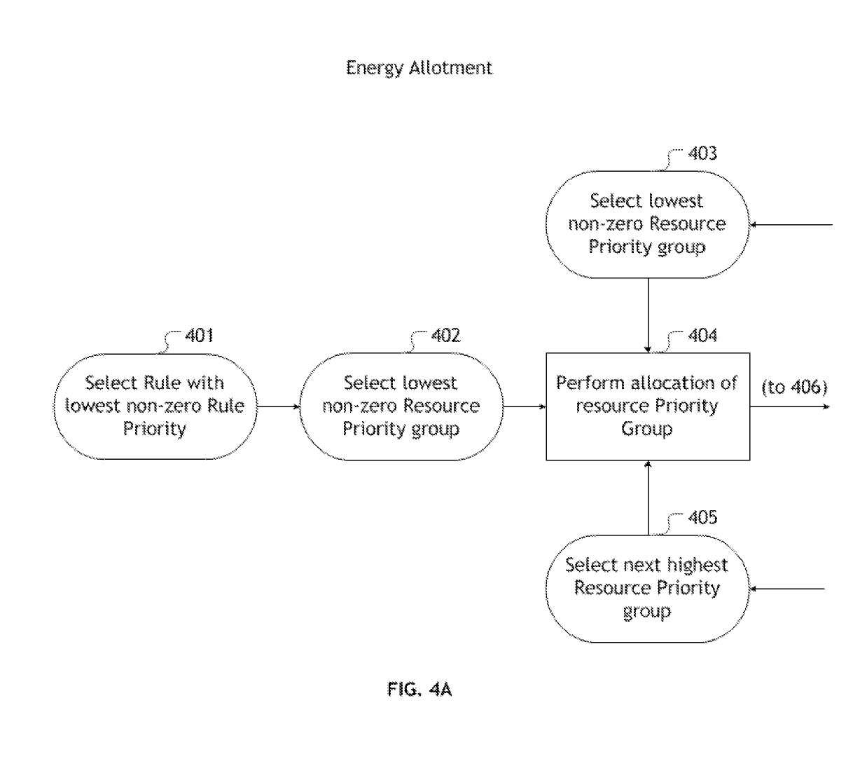

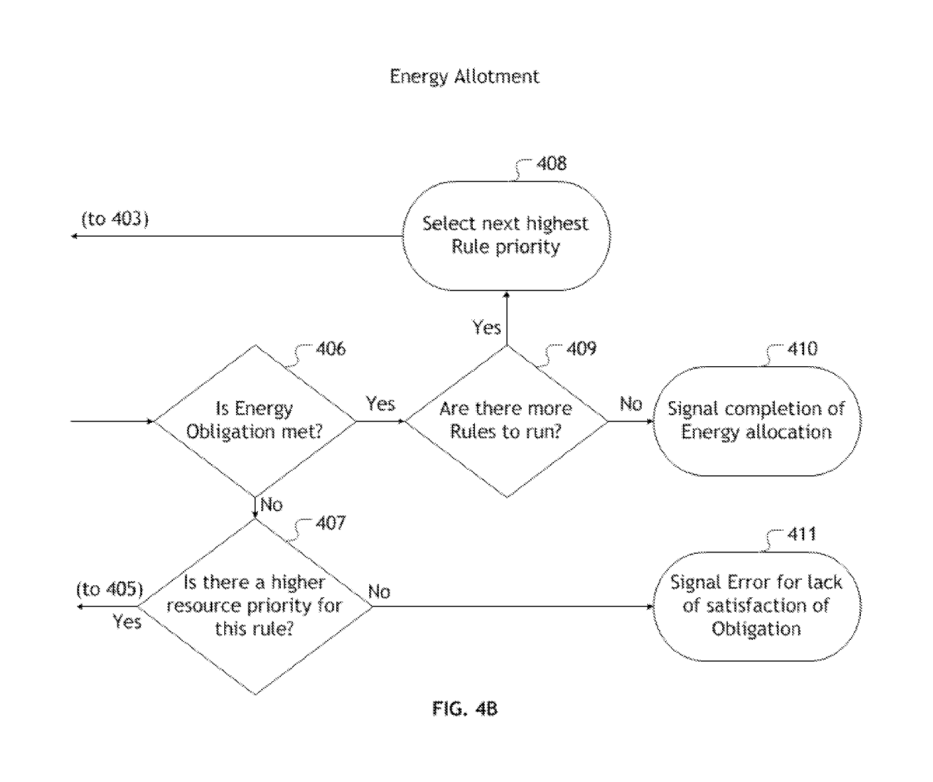

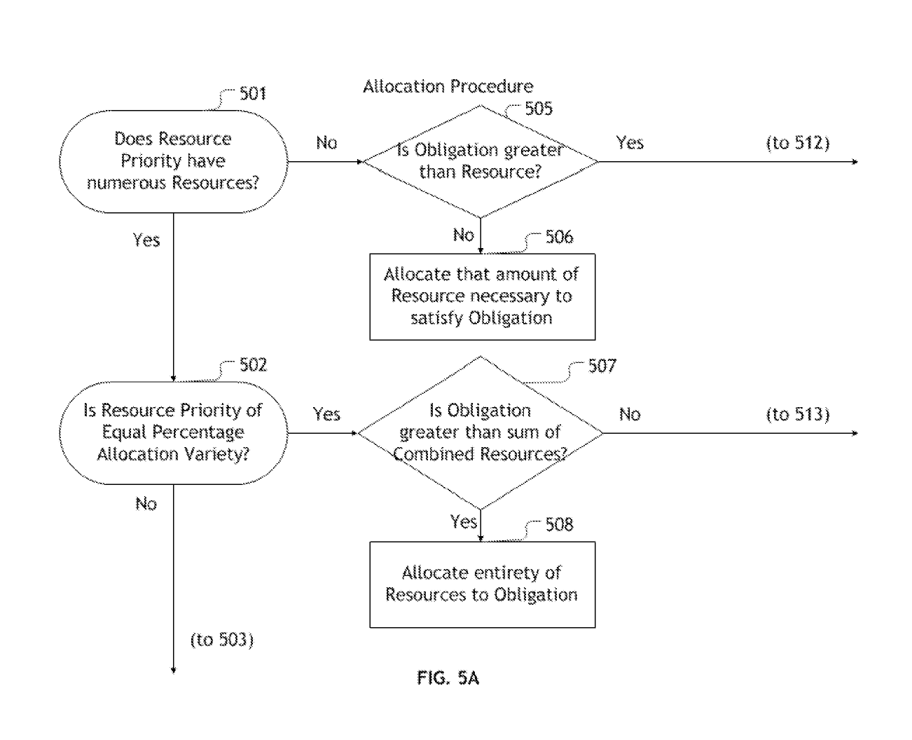

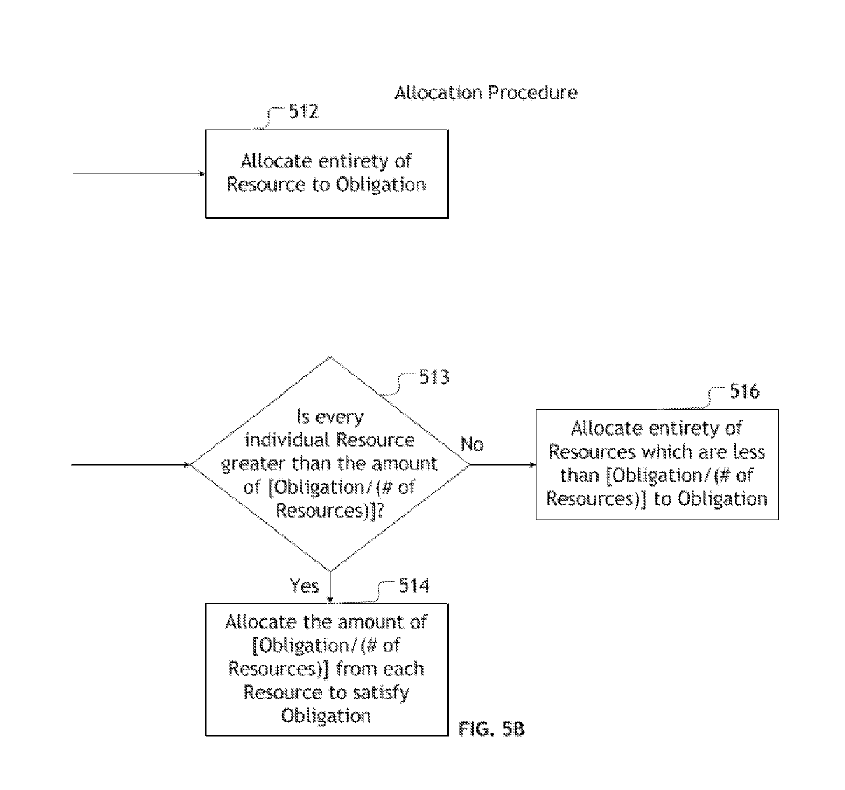

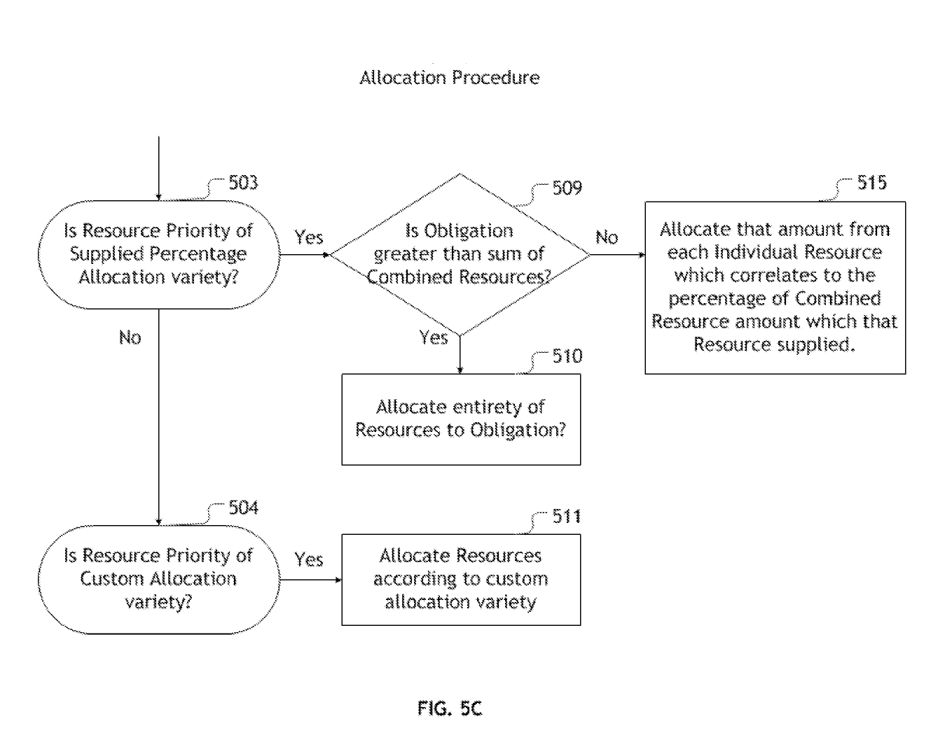

Upon completion of energy balancing 112, the system can attribute 113 energy and RECs 101 to obligations. This is done through a rule engine within the software system as seen in FIGS. 4, and 5. This rule engine allots RECs 101 and energy to Obligations based on predefined rules that are executed in a specific order. The system allows the user to define this order and can change the order at any time. These rules can be predefined by the user, the developer of the system, or another entity.

Every Obligation is represented by a single rule. The system may also allow a rule to be created automatically when a particular Obligation is modeled 111 in the system. The system looks for every rule to be assigned to only one Obligation. The rule does so by allocating one or more Resources to this Obligation. Resources can be added or removed from a rule's Resource set.

In one particular embodiment, the system can allow a user to alter the order in which rules are executed by changing said rule's priority level (Rule Priority). Rules can be modified or effectively deactivated by setting the Rule Priority to a null value. In one particular embodiment, system can be configured to allow Rule Priorities to be distinguished with numbers.

A generating resource's energy and RECs 101 may be utilized in a symmetric or asymmetric manner to meet the Obligation, depending on how the resource attribution priorities are set up within the rule. Symmetric attribution means that energy and REC priorities are assigned equally (i.e. RECs follow energy). Asymmetric attribution means that energy and RECs are assigned separately.

if a rule is defined as symmetric, a single priority value is allowed for each resource in the rule definition. This priority value is used for both energy and REC allocation. If a rule is defined as asymmetric, independent priority values are allowed for both energy allocation and REC allocation. As a non-limiting example, users can create a rule using the asymmetric type, in which several resources supply energy but only one supplies REC to the Obligation.

Within a single rule, the assignment by the system of Resource Energy and/or RECs 101 is governed by allocation policies and resource priorities as assigned by the user. The system is arranged such that each resource within a rule is given a value which will dictate what order Resources are allotted to rules. As a non-limiting example, the system may allow users to set priorities by assigning whole numbers to indicate order of allocation, where such whole number corresponds to a priority (Resource Priority), If a user inputted a negative or non-whole number, the system would return an error. Each time that RECs are allocated to an Obligation, the systems records this as a transaction (Transaction). Turning now to FIGS. 3 and 4, the system then prioritizes the Resources, such as by giving the lowest positive whole number assigned to a Resource the “highest” priority granted 302/402, such that said Resource is attributed to the Obligation prior in the attributing sequence.

Turning now to FIG. 5, a single Resource in a Resource Priority would be evaluated as to whether or not it is greater than the Obligation 505. If the Resource is greater than the Obligation 505, the system would attribute enough Energy or RECs 101 to satisfy the Obligation 506. If the single Resource is less than the Obligation 505, the system would attribute the entirety of the Resource to the Obligation 512. The rule would not move to the next highest Resource Priority on the Rule until all lower Resource Priorities had been exhausted. A Resource Priority can have one or multiple Resources 501. If the user chooses to have multiple Resources sharing the same Resource Priority, the user can then specify how Energy and RECs are attributed from the Resources to the Obligations. Attribution policies may comprise Equal Percentage Allocation 502 and Supplied Percentage Allocation 503. Users may also create custom attribution policies 504 on top of these to attribute their Resource as they desire 511. If the user has specified Equal Percentage Allocation 502, then the Obligation is divided into as many parts as there are Resources in that Resource Priority and all such Resources contribute the same amount to satisfy the Obligation 514. In one non-limiting example, if the Obligation is twelve and Resource A, B, and C have the same Resource Priorities and individual values of 5, 8, and 20, respectively, each Resource has 4 taken from it to meet the Obligation, so that the final values of A, B, and C after the allocation of this rule are 1, 4, and 16, respectively. If one or more Resources do not have enough capacity to supply this amount 513 then these Resources are first fully exhausted towards the Obligation 516, after which Equal Percentage Allocation again divides equally among remaining Resources of that Resource Priority 514. In one non-limiting example, if the Obligation is twelve and Resources A, B, and C have the same Resource Priority and individual values of 2, 8, and 20, respectively, then first Resource A is used completely followed by B and C handling equal shares of the remainder, so that the final values of A, B, and C are 0, 3, and 15, respectively. If the sum of all Resources of selected Resource Priority is determined to be insufficient to meet the Obligation 507 then all Resources of selected Resource Priority will be used completely for the Obligation 508 and the system will move to the next Resource Priority 305/405.

If the user has instead specified Supplied Percentage Attribution 503, then the Resources of applicable Resource Priority is attributed that percentage of the Obligation which correlates to said Resources' supplied/generated Energy in relation to other Resources of same Resource Priority 515. As a non-limiting example, if the Obligation is 20 and Resources A, B, and C all have the same Resource Priority and individual values of 10, 10, and 20, then A and B give half the amount of C as they have half the initial amount, resulting in final values of 5, 5, and 10 for Resource A, B, and C, respectively. Regardless of the allocation procedure, if the Resources in the Resource Priority do not have a combined value great enough to meet the Obligation, all Resources use the entirety of their value towards the Obligation for that Resource Priority 508/510. If the sum of all Resources in the Resource Priority group is less than the Obligation 509, then the system ensures that all Resources ⁻will be exhausted for the selected Obligation 510 and the system will select the next Resource Priority group will be selected 305/405. This continues until either the Obligation has been met or all Resources have been exhausted 308/409.

A rule is executed when the specified Obligation is fully satisfied by the Resources associated with the rule 308 409. If ever an energy Obligation cannot be satisfied due to insufficient Resource capacity or any other reason, the system will generate an error message 411 and the sequence halts. Together, rules comprise an execution sequence, as seen in FIG. 3 and FIG. 4 for RECs and Energy, respectively. This sequence is generated once, in a downstream manner, to perform generation attribution. Each rule can only execute once in a given execution sequence. The system allows for generation attribution to be performed with a manual request. In one particular embodiment, user may also manually adjust attribution results before locking the attribution.

Altogether, the system's Attribution rule engine 113 functions by selecting that rule with the “first” Rule Priority 301/401, selecting the “first” Resource Priority group within that rule 302/402, and performing whatever attribution policies exist within that Resource Priority group 304/404. If the REC Obligation 306 and/or Energy Obligation 406 is not met, the system will select the next Resource Priority 305/405 if there is another Resource Priority present 307/407. This continues until the specific Resource Priority is finished. When finished, if there are more rules to run 309/409 the system will select the next Rule Priority 308/408 and again select the “first” Resource Priority group 303/403. At the end, the system will signal completion of both REC 310 and Energy 410 attribution.

For one particular embodiment, a user can decide to what level of accuracy RECs are calculated. The level of accuracy is configurable, to settings such as but not necessarily linked to, configurations in which the values of RECs are always displayed in whole numbers, and any decimal numbers during calculations are rounded to the nearest integer. The system also may allow rounding to commence upon completion of each step in the attribution process 113 via a rounding algorithm or other equivalent operation. This algorithm may operate by rounding each allocation individually using natural rounding, after which the sum of unrounded Resource outputs is obtained and rounded, after which the sum of rounded Resource outputs is obtained, after which the two totals (rounded and unrounded Resource outputs) are compared. If the totals are not equal, individual Resource outputs are individually adjusted in the ascending order of least impact until both totals are equal.

In one particular embodiment, the system may also perform limits monitoring during the attribution calculations 113, defined as validating whether a REC violation exists after every attribution step. If a violation is found, the attribution is stopped and an error message is generated. The system can monitor possible violations such as but not necessarily limited to the inaccurate attribution of RECs. Bilateral Contracts 108 may be marked in such a way that the system tracks whether the percentage of RECs assigned to the contract is less than the percentage of the RECs 101 assigned to the system load; if it is, the system can signal a violation. This monitoring may be configured to happen continuously during attribution.

The system also allows the user to individually create transactions with the Transaction Management tool 114. The Transaction Management tool 114 facilitates the user allocation of RECs to Obligations by specifically setting which RECs from which source are to be allocated. Transactions can be created via the Transaction Management tool 114 both before and after attribution engine 113 is used. If a Resource has already been attributed in some capacity, the Transaction Management tool 114 can take allocated RECs 101 originating from user-created Transactions out of Resource pools so that RECs 101 are not used twice.

After Transactions have been completed in either the Transaction Management tool 114 or the attribution engine 113, the allocated RECs 101 and Energy can be displayed in numerous configurations to communicate a user's final REC position 115. The system may be configured such that scenarios in which Energy delivered to counterparties and markets is in excess of RECs 101 supplied are flagged by the system in a display as containing unbundled RECs 101 which can be sold 116. A user can view this information in graphical format.

The system may also create reports 117. The system may be configured to generate reports 117 such as but not necessarily limited to reports of imported or manually inputted values of RECs 101 and energy. Reports 117 may also be made available which give information on standard bilateral contracts 107 or provide standard energy component reports 117. Flowed energy values, segregated by product, may be displayed after being retrieved by system from imported data 201. Offered and accepted energy values, broken down by product, may be reported after being retrieve from user-entered data. Curtailed energy values for each product may be calculated by subtracting flowed energy values from accepted energy valued.

The system may also generate a report 117 on the generation attribution (by fuel type) for the energy deliveries to foreign entities by organizational permits. This report 117 may be built internally by the system to itemized volumetric deliveries as well as received revenue under organizational permits by generation fuel types. Reports 117 may be generated at any time based upon available Vintage Months.

The system also grants the user the ability to create and view pivot tables with the Transaction data. Once the user specifies a date range, the data populates into a database for display as a chart. The user can then manipulate what information is to be calculated, based on what variables and in what arrangement. The system facilitates user modification of how data is organized in the chart for display by clumping together similar data points into mini-tables within the whole display. In one particular embodiment, the chart configurations may be saved for personal or public viewing or reference.

What is claimed is:

1. A method of managing renewable energy credits (RECs) comprising:
a. providing a server, having memory, to run a program for managing RECs;
b. importing data into the server memory, the imported data comprising one or more resources, the RECs generated from the one or more resources, the energy generated from the one or more resources, and one or more obligations;
c. allocating RECs to the one or more obligations using one or more predefined rules;
d. allocating energy to the one or more obligations using one or more predefined rules;
e. providing the user with a REC position.

2. The method of managing renewable energy credits (RECs) of claim 1 wherein the imported data is validated, and further wherein an error is communicated to the user if the imported data fails validation.

3. The method of managing renewable energy credits (RECs) of claim 1 wherein the energy and REC inputs are comprised of the energy generated from each of a plurality of generating resources, the energy used by each of the plurality of generating resources, the native load, the RECs earned from each of the plurality of generating resources, and energy imports, and further wherein the one or more obligations is comprised of the energy sold through contracts and/or to one or more market(s), and further wherein the data imported comprises the current pricing for RECs in each of a plurality of regions.

4. The method of managing energy and renewable energy credits (RECs) of claim 3 further including the step of modeling imported data by matching incoming obligations with the energy sources and/or RECs.

5. The method of managing renewable energy credits (RECs) of claim 3 further including the step of calculating the energy balance of factors comprising the resource generation, energy inputs, native load, stations service, and obligations.

6. The method of managing renewable energy credits (RECs) of claim 1 further including the step of creating one or more rules to allocate RECs and/or energy to obligations.

7. The method of managing renewable energy credits (RECs) of claim 3 wherein RECs from one source may be allocated independently of the energy of the same source.

8. The method of managing renewable energy credits (RECs) and/or energy of claim 6 wherein allocated RECs and/or energy are assigned resource priorities that specify the order in which those resources will be allocated during execution of the rule.

9. The method of managing renewable energy credits (RECs) and/or energy of claim 8 wherein RECs and/or energy on the same resource priorities can have an equal percentage allocation.

10. The method of managing renewable energy credits (RECs) and/or energy of claim 8 wherein RECs and/or energy on the same resource priorities can be allocated using supplied percentage allocation.

11. The method of managing renewable energy credits (RECs) of claim 1 wherein each transaction is comprised of a transaction type, resource, vintage month, REC quantity, price, currency, broker name, broker commission type, broker commission dollar amount and deal date.

12. The method of managing renewable energy credits (RECs) of claim 1 further including limit monitoring during REC allocation.

13. The method of managing energy of claim 1 further including the step of stopping allocation and signaling an error if an energy obligation is ever unsatisfied at the conclusion of a rule.

14. The method of managing renewable energy credits (RECs) of claim 1 further including the step of communicating excess RECs, which can then be sold.

15. The method of managing renewable energy credits (RECs) of claim 1 further including the step of generating one or more reports.

16. Renewable energy credit management system comprising:
a computer program for use with a graphics display device,
the computer program comprising a computer usable medium having computer readable program code means embodied in the medium for modeling, organizing, and reporting an organization's renewable energy credits (RECs) generation and allotment.

17. The renewable energy credit management system of claim 16 wherein the computer program further comprises computer readable program code means for creating a rule governing REC/energy allotment from entities to a given obligation (Obligation).

18. The renewable energy credit management system of claim 17, wherein the rule comprises a plurality of energy components, the finished allotment for this Obligation then being turned into a single rule.

19. The renewable energy credit management system of claim 17 wherein the rules are arranged in specified sequential order.

20. The renewable energy credit management system of claim 16 wherein the computer readable program code means also provides means for displaying a report on REC generation and allotment.

21. The renewable energy credit management system of claim 16 wherein the computer readable program code means for analyzing, monitoring, and projecting past, present, and future REC generation and allotment.

22. The renewable energy credit management system of claim 17 where each Rule is built with with all necessary characteristics as far as its data needs, execution logic, and interaction with users are concerned.

23. The renewable energy credit management system of claim 16 wherein a transaction is created every time a REC is allotted in the system.

24. A renewable energy credit management system comprising:
a computer program for use with a server having a memory,
a computer program running in the memory for modeling, organizing, and reporting an organization's renewable energy credit (REC) generation and allotment, the computer program being configured to:
a. import data into the server memory, the imported data comprising one or more resources, the RECs generated from the one or more resources, one or more obligations, and REC prices;
b. allocate RECs to the one or more obligations using one or more predefined rules;
c. allocate energy to the one or more obligations using one or more predefined rules;
d. create a transaction for each REC allocated;
e. provide a REC position.
